(19) United States
(12) Patent Application Publication
(10) Pub. No.: US 2017/0332802 A1
(43) Pub. Date: Nov. 23, 2017

(54) SUPPORT SYSTEM

(71) Applicant: Fulcrum Product Development, Providence, RI (US)

(72) Inventor: Douglas Stern, Providence, RI (US)

(21) Appl. No.: 15/597,837

(22) Filed: May 17, 2017

Related U.S. Application Data
(60) Provisional application No. 62/338,617, filed on May 19, 2016.
(60) Provisional application No. 62/339,562, filed on May 20, 2016.

(51) Int. Cl. A47C 27/10; A61G 5/10; A47C 27/08; A47G 9/10

(52) U.S. Cl. CPC A47C 27/10; A47G 9/1081; A47G 9/1027; A61G 5/1048; A61G 5/1045; A47C 27/082

(57) ABSTRACT

A support system includes two cushions. The first cushion is divided into a plurality of bladders filled with a fluid, the bladders being connected by fluid interconnections. The second cushion is coupled to the first cushion. The second cushion is also divided into a plurality of bladders filled with a fluid, the bladders connected by fluid interconnections. When a force is applied to one of the plurality of bladders, a reactionary force is produced in a different one of the plurality of bladders in the same respective cushion.

### CROSS-REFERENCE TO RELATED APPLICATION

This application claims priority to U.S. Provisional Patent Application No. 62/338,617 filed on May 19, 2016 and U.S. Provisional Patent Application No. 62/339,562 filed on May 20, 2016 which are incorporated herein by reference.

### FIELD OF THE INVENTION

The subject disclosure relates to ergonomic and/or medical support systems and apparatus, and more particularly to support systems that control fluid flow between bladders.

### BACKGROUND OF THE INVENTION

Many people suffer from poor posture for a variety of reasons, including spending most of the day in a bed or a chair, being overweight or underweight (or gaining/losing weight while using wheelchair), having poor bladder or bowel control, having deceased feeling in an area of the body, or spending a lot of time in one position. Improper positioning often causes pressure ulcers in many areas of the body including: Heels and ankles, knees, hips, spine, tailbone area, elbows, shoulders and shoulder blades, back of the head, and ears. Further, poor positioning and/or posture can result in any of the following: back/spine related problems, scoliosis, lumbar problems, hyperlordosis, spinal stenosis, osteogenesis imperfecta, cerebral palsy, hemiplegia, motor neuron disease, spinal injuries, spina bifida, muscular dystrophy, arthritis, degenerative disease, skin tears, bedsores, pressure sores, or the like. Medical practitioners and nurses are faced with the problem of repositioning and comforting a patient to solve these issues. Therefore there is a need to create a universal system that will be able to be reconfigured to address many of the pathology causes and effects from poor and uncorrected posture.

In particular, as the population continues to grow and age, so does the number of elderly and disabled people. The elderly and disabled tend to spend more time confined to a bed, chair, or the like. In such cases, it is important for the care, comfort, and health of the individual to have a support system that provides comfort and adequate support. Therefore there is a need for better solutions to support and reposition the disabled, elderly and people that are in rehabilitation.

Additionally, health care resources are often limited and caregivers are left with only the ability to improvise with a multitude of ad hoc components in order to reposition a patient. Wheelchairs are often purchased with government subsidies and insurance providers. These providers only allow a purchase of one piece of equipment every ten years. Because of this long length of time, here is a need to create a system that will evolve with the patient's needs. Often there is a significant change in weight that occurs when a person becomes sedentary and the wheelchair or other equipment can quickly become outdated.

While various support systems are currently available, such as positioning pillows and seat cushions, there are no comprehensive systems capable of providing effective support for the user which can adapt to the needs of the user. Further, many available systems are expensive, cannot be easily washed, have disconnected components, and/or are not easily incorporated into typical base structures, such as a wheelchair.

### SUMMARY

In light of the above, the subject technology provides a support system which is easily adaptable to provide support and reposturing for users, particularly for the disabled, elderly, and others who are confined to a chair, bed, or the like. Further, the subject technology provides a support system which is relatively cheap, easy to implement, versatile, and can be readily attached to base structures, such as a wheelchair.

In some embodiments, the support system includes a first bladder containing a fluid. A second bladder also contains a fluid, the second bladder being fluidly connected to the first bladder. A valve controls fluid flow between the first bladder and the second bladder. Applying a force to the first bladder causes a reactionary force in the second bladder, via the fluid connection between the bladders. Similarly, applying a force to the second bladder causes a reactionary force in the first bladder via the fluid connection. In some embodiments, the first bladder has an axial partition dividing the first bladder into a plurality of support zones. The first bladder can also have a transverse partition further dividing the first bladder into a plurality of support zones. In some cases, the second bladder also has an axial partition dividing the second bladder into a plurality of support zones. The second bladder can also have a transverse partition dividing the second bladder into a plurality of support zones.

In at least some embodiments, the support system includes a plurality of zone valves controlling fluid flow between the support zones. A first cushion can enclose the first and second bladders. A plurality of first cushion fasteners can be attached to the first cushion. In some cases, a disposable sanitary barrier attached to the first cushion via the first cushion fasteners. The system can include adjustment straps with quick release connectors, the adjustment straps coupled to the support system via the fasteners. In some embodiments, the support system includes a second cushion containing a third bladder filled with a fluid and a plurality of second cushion fasteners attached to the second cushion. Some of the second cushion fasteners are coupled with some of the first cushion fasteners to couple the first and second cushions. In some cases, the system includes a rigid board attached to the second cushion via coupling with the first cushion fasteners. The system can also include a third cushion containing a fourth bladder filled with a fluid. A plurality of third cushion fasteners can be attached to the third cushion. Some of the third cushion fasteners then couple with some of the second cushion fasteners to couple the second cushion and the third cushion. The first bladder can also include a nozzle for injecting additional fluid into the first bladder. The nozzle can also be utilized to release fluid from the first bladder.

In some embodiments, the subject technology relates to a first cushion divided into a plurality of bladders filled with a fluid, the plurality of bladders being connected by fluid interconnections. Further, a second cushion is coupled to the first cushion, the second cushion divided into a plurality of bladders filled with a fluid, the bladders being connected by fluid interconnections. Therefore when a force is applied to one of the plurality of bladders, a reactionary force arises in a different one of the plurality of bladders in the same respective cushion. In some embodiments, the first cushion includes a nozzle in fluid connection with one of the plurality of bladders of the first cushion. The nozzle allows for the injection of additional fluid into the first cushion and the release of the fluid from the first cushion. At least one of the plurality of bladders can be divided into a plurality of support zones of different flexibility. Further, the system can include at least one fluid interconnection between the plurality of support zones, the at least one interconnection including an adjustable valve operable to control fluid flow between the support zones. In some embodiments, the subject technology includes a plurality of fasteners attached to the first and second cushions. The plurality of fasteners have a uniform structure for coupling with other fasteners of the same uniform structure. In some embodiments the system also includes a rigid board attached to the second cushion by the fasteners. The first cushion can be positioned perpendicular to the second cushion.

### BRIEF DESCRIPTION OF THE DRAWINGS

So that those having ordinary skill in the art to which the disclosed system appertains will more readily understand how to make and use the same, reference may be had to the attached drawings.

FIG. 1a is a side view of a user utilizing a support system in accordance with the subject technology.

FIG. 1b is a top view of a user utilizing a support system in accordance with the subject technology.

FIG. 2a is a top view of a cushion from a support system in accordance with the subject technology.

FIG. 2b is a side view of a cushion from a support system in accordance with the subject technology.

FIG. 3a is a top view of a cushion from a support system in accordance with the subject technology.

FIG. 3b is a top view of a cushion from a support system in accordance with the subject technology.

FIG. 4a is a top view of a cushion from a support system in accordance with the subject technology.

FIG. 4b is a top view of a cushion from a support system in accordance with the subject technology.

FIG. 5a is a top view of a bladder from a support system in accordance with the subject technology.

FIG. 5b is a top view of a bladder from a support system in accordance with the subject technology.

FIG. 5c is a top view of a bladder from a support system in accordance with the subject technology.

FIG. 5d is a cross sectional view of a cushion from a support system in accordance with the subject technology.

FIG. 5e is another cross sectional view of a cushion from a support system in accordance with the subject technology.

FIG. 6a is a perspective view of a fastener from a support system in accordance with the subject technology.

FIG. 6b is a cross sectional view of a fastener from a support system in accordance with the subject technology.

FIG. 6c is a perspective view of a fastener from a support system in accordance with the subject technology.

FIG. 6d is a top view of a fastener from a support system in accordance with the subject technology.

FIG. 6e is a top view of a fastener from a support system in accordance with the subject technology.

FIG. 7a is a perspective view of a fastener from a support system in accordance with the subject technology.

FIG. 7b is a front view of a fastener from a support system in accordance with the subject technology.

FIG. 7c is a perspective view of a fastener from a support system in accordance with the subject technology.

FIG. 7d is a top view of a fastener from a support system in accordance with the subject technology.

FIG. 7e is a top view of a fastener from a support system in accordance with the subject technology.

FIG. 8 is a perspective view of a support system in accordance with the subject technology.

FIG. 9 is a perspective view of a support system in accordance with the subject technology.

FIG. 10a is a perspective view of a board for a support system in accordance with the subject technology.

FIG. 10b is a front view of a board for a support system in accordance with the subject technology.

FIG. 11a is a perspective view of support system in accordance with the subject technology attached to a wheelchair.

FIG. 11b is a perspective view of support system in accordance with the subject technology attached to a wheelchair.

FIG. 11c is a perspective view of support system in accordance with the subject technology attached to a wheelchair.

FIG. 12a is a top view of a support system implemented within a pillow in accordance with the subject technology.

FIG. 12b is a perspective view of a support system implemented within a pillow in accordance with the subject technology.

FIG. 12c is a front view of a support system implemented within a pillow in accordance with the subject technology.

FIG. 12d is a side view of the internal bladders within the pillow of FIGS. 12a-c.

FIG. 12e is a side view of the internal bladders within the pillow of FIGS. 12a-c.

FIG. 13a is a cross sectional view of a user preparing to use a support system within a pillow in accordance with the subject technology.

FIG. 13b is a cross sectional view of a user using a support system within a pillow in accordance with the subject technology.

### DETAILED DESCRIPTION OF PREFERRED EMBODIMENTS

The advantages, and other features of the system disclosed herein, will become more readily apparent to those having ordinary skill in the art from the following detailed description of certain preferred embodiments taken in conjunction with the drawings which set forth representative embodiments of the present technology and wherein like reference numerals identify similar structural elements. It is understood that references to the figures such as up, down, upward, downward, left, and right are with respect to the figures and not meant in a limiting sense.

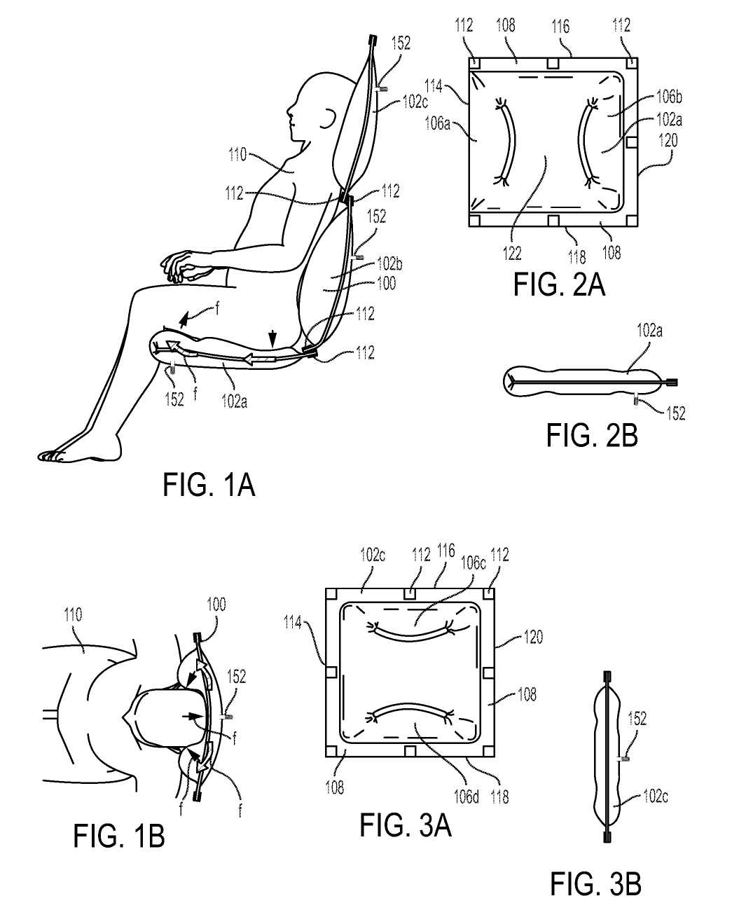

Referring to FIGS. 1a-1b, a user 110 is shown, sitting in a support system 100 in accordance with the subject technology. In general, the support system 100 serves as a cushioning and support system which allows for easy adjustments and/or repositioning for a user. The support system 100 uses fluid displacement technology to redirect or redistribute fluid to different cells or zones. For the sake of simplicity, in the embodiment shown, the support system 100 is shown apart from any underlying base structure (i.e. a bed or a wheelchair). The support system 100 includes three separate cushions 102a, 102b, 102c which are attached via fasteners 112. Within each cushion are a number of bladders which contain fluid. In most cases, the bladders within a given cushion form a fluid connection with one another, allowing the fluid to pass between the bladders. The fluid might be air, water, or foam, for example, or any other fluid which can be contained within the bladders as described herein. Valves between the bladders are calibrated and adjusted to control fluid flow between the bladders for ideal comfort. For instances, in the example shown, as the user sits down, the weight of their body and head on the cushions 102a, 102c causes displacement of the fluid, indicated by displacements arrows “f”, and cause the cushions 102 to conform to the shape of the user's body 110. Notably, although three cushions 102 are shown by way of example, it should be understood that the support system 100 can include various amounts of support cushions 102 in different embodiments (i.e. one, two, four, ten, etc.).

Referring now to FIGS. 2a-3b, individual cushions 102 for a support system 100 in accordance with the subject technology are shown. The first cushion 102a is similar to the lower cushion 102a shown in FIG. 1a and the second cushion 102c is similar to the upper cushion shown in FIGS. 1a and 1b, the difference being that the cushions 102 in FIGS. 2a-3b are not in use. In the example shown, there is a relatively uniform distribution of fluid throughout the bladders 106 within each cushion 102 (notably fluid distribution can be made uneven by partitioning the bladders or adjusting valves within the bladders, as discussed more fully herein). The flow of fluid between the bladders 106 of a given cushion 102 is controlled, at least in part, by regulating the flow of fluid through interconnections within the cushions.

Referring now to FIGS. 1a-3b, each cushion 102 includes a border 108 which has a number of fasteners 112 for coupling with fasteners 112 attached to other cushions, or in some cases, fasteners 112 attached to external components. The lower cushion 102a has a first bladder 106a which is positioned near the front side 114 of the cushion 102a and a second bladder 106b which is positioned near the back side 116 of the cushion 102a. The first and second bladders 106a, 106b are fluidly connected such that applying a force to the first bladder 106a causes a reactionary force in the second bladder 106b (and therefore an increase of fluid in and expansion of the second bladder 106b) and vice versa. For example, as shown in FIG. 1a, when a user 110 sits on top of the lower cushion 102a with their torso positioned predominately over the second bladder 106b, fluid is pushed into the first bladder 106a, which is subject to a lesser force, along flow arrows “f” via fluid interconnections (not distinctly shown). This provides a cushion for the user 110 while holding the user 110 in an upright position, helping them maintain good posture. While the lower cushion 102a contains a border 108 with fasteners 112 on the sides 116, 118 and rear 120, no border 108 or fasteners 112 are disposed on the front side 114 (aside from fasteners 112 attached to the side walls 116, 118 where they join with the front side 114). This orientation is desirable to maximize comfort when the cushion 102a is configured so that the user's 110 legs will be positioned over the front side 114, as shown in FIG. 1a.

Further, in the example shown in FIG. 1a, the lower cushion 102a is connected to the middle cushion 102b via fasteners 112, the middle cushion 102b being connected, in turn, to the upper cushion 102c. The middle cushion 102b contains a larger amount of fluid than the lower or upper cushions 102a, 102c to provide support for the arch in the user's 110 lower back. The upper cushion 102c has bladders 106c, 106d positioned near the sides 116, 118. Therefore as the user 110 places their head in the central portion 122 of the bladder 102c, fluid is forced to the outer portions of the bladders 106c, 106d, as shown by flow arrows “f”, to provide support for the user's 110 head.

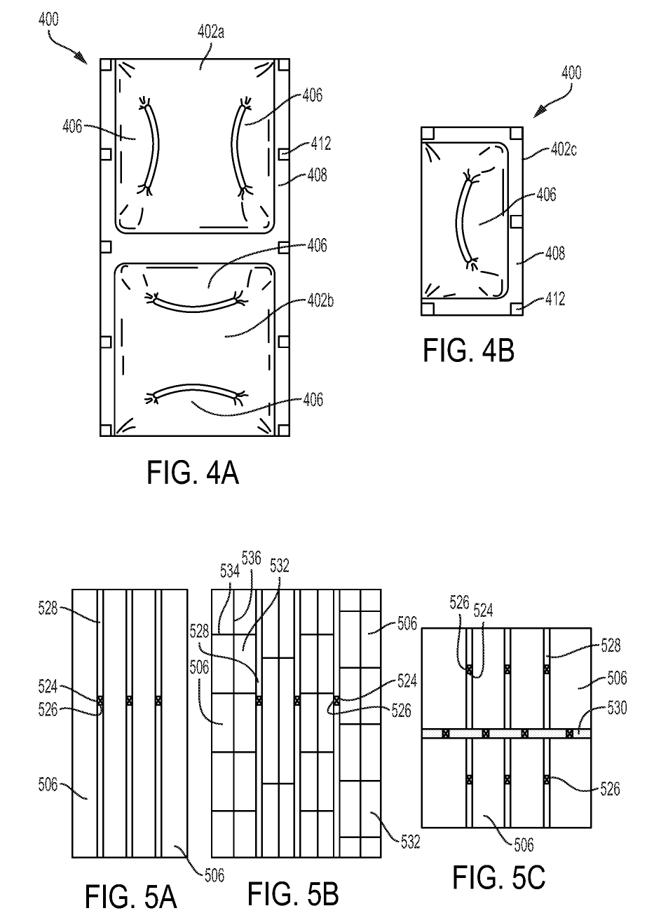

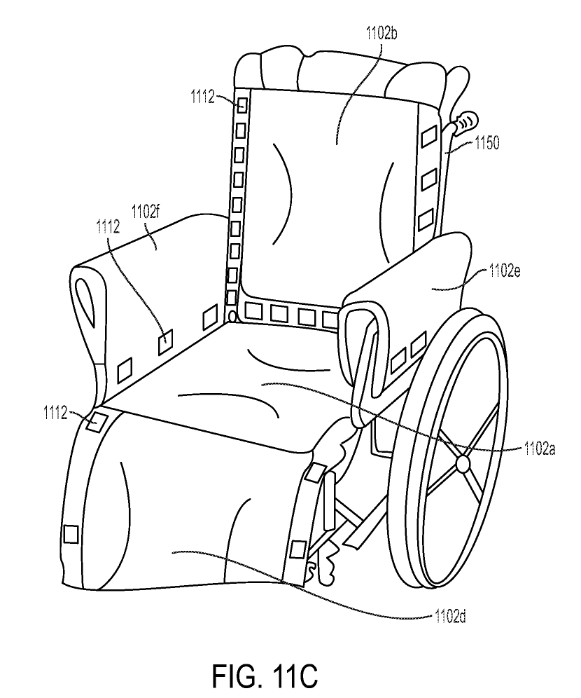

Referring now to FIGS. 4a-4b, other orientations of cushions 402 for support systems 400 are shown. FIG. 4a shows an orientation where two cushions 402a, 402b, are attached to one overall support system 400. The cushions 402a, 402b can be removably attached via fasteners 412 or similar mechanical connectors. Alternatively, the cushions 402 can be permanently attached, for example, by forming the cushions 402 from a single piece of material with each cushion 402 containing separate bladders 406 within a separate section of the overall support system 400. FIG. 4b shows a cushion 402c which is truncated, as compared to the other cushions 402a, 402b discussed above. The truncated cushion 402c can have a single bladder 406 as shown, or can use multiple bladders 406. The truncated cushion 402c also includes fasteners 412 for easy coupling with other cushions 402 within a support system 400. For example, truncated cushions 402c can be attached to the side walls 116, 118 of the lower cushion 102a, and positioned perpendicularly to the lower cushion 102 (i.e. see FIG. 11b). This can provide side support to a user 110 who is sitting in a chair with arm rests, for example, like the wheelchair shown in FIG. 11c.

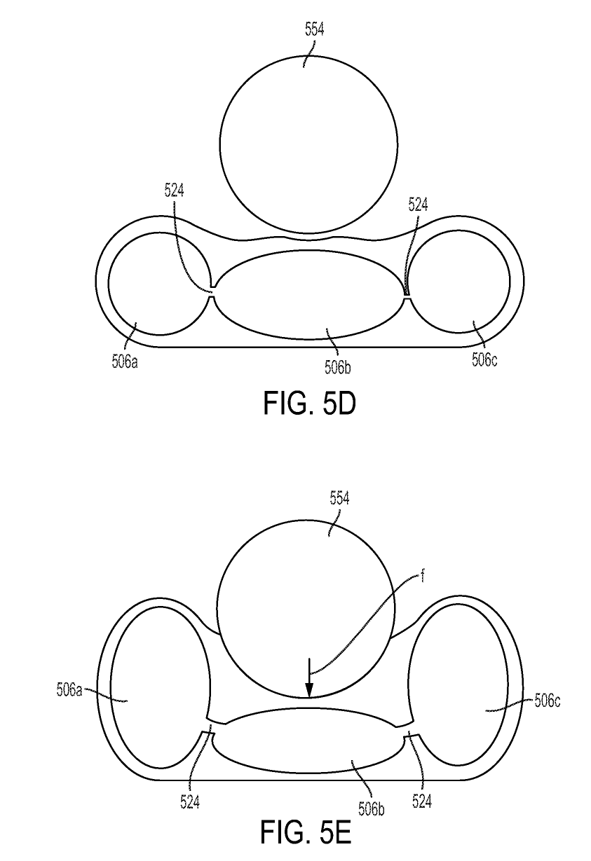

Referring now to FIGS. 5a-5c, the interior fluid connections 524 (or interconnections 524) of bladders 506 are shown. The interconnections 524 allow the fluid to flow between the bladders 506, as discussed above. In the examples shown, FIG. 5a shows a bladder arrangement typical of a truncated cushion (i.e. 402c in FIG. 4b) while FIGS. 5b and 5c show a bladder arrangement typical of the larger cushions (i.e. 402a, 402b in FIG. 4a). Valves 526 within the interconnections 524 allow for the flow of fluid between the bladders 506 to be controlled. For example, the valves 526 can be used to throttle fluid flow, limiting the flow rate between the bladders 506 so that when a large force is applied to one of the bladders 506, there is a delayed reaction before the fluid is forced into other bladders 506. This can help prevent the support systems from overreacting in response to movement that causes a quick but non-sustained force on the system. Alternatively, the valves 526 can provide a resistance to fluid exchange between two bladders 506 such that fluid will not flow through one or more of the valves 526 until a certain amount of force is applied to one of the bladders 506. In such a way, the valves can control the pitch and/or depth of the bladders 506 in various areas of a cushion.

The bladders 506 and interconnections 524 can be arranged in various patterns. For example, in FIGS. 5a, the bladders 506 are divided by axial partitions 528 with the interconnections 524 running transversely across the partitions 528 between the bladders 506. In FIG. 5c, the bladders 506 are further divided by a transverse partition 530 with valves 526 controlling flow through axial interconnections 524 between bladders 506. While for simplicity the bladders 506 are only shown forming a fluid connections with other adjacent bladders 506, it should be noted that multiple fluid interconnections 524 can be provided to place some, or all, of the bladders 506 in fluid connection with one another. For example, tubes or channels can be placed between every bladder 506 and every other bladder 506 within a given cushion, forming interconnections 524 in between them, such that when a force is applied to one bladder 506, a fluid reaction can occur in every other bladder 506.

Further, as shown in FIG. 5b, the individual bladders 506 can be divided into various support zones 532 within that bladder 506. For example, transverse and axial partition walls 534, 536 can run throughout a bladder 506. The partitions 534, 536 may have openings to provide interconnections between the other support zones 532 (not distinctly shown). Much like the interconnections 524 described between the bladders, these interconnections place the zones within fluid connection and may also include valves 526 for controlling fluid flow (i.e. zone valves which specifically control fluid flow through the partitions between zones). Alternatively, a zone 532 can be completely fluidly sealed from the other zones 532 to maintain a fluid level that is independent of the other zones 532. Alternatively, a zone 532 can be filled with a solid, non-fluid substance, for example, to provide a cushion in a particular area. In general, the different zones 532 can be formed by different material, such as material with a different flexibility, to effect the level to which a certain zone 532 responds to force on a different zone 532. For example, a zone formed by a material with a very low flexibility will expand less, in response to fluid pressure within that zone, than a zone formed by a material of very high flexibility.

Referring now to FIGS. 5d-5e, cross sectional views of a system in accordance with the subject technology are shown, showing the function of the bladders 506 within the system when a force is applied. FIG. 5d shows the system with a weight 554 sitting just above the middle bladder 506b. The weight 554 is then lowered, along arrow “f”, onto the middle bladder 506b. This causes fluid in the middle bladder 506b to disperse, through interconnections 524, into the outer bladders 506a, 506c. In this way, the weight 554, which could be a user's head, for example, is cushioned by the middle bladders 506b while also being held in place by the expanded side bladders 506a, 506c. Typically, in embodiments such as the one shown, the bladder 506 which will be taking weight (or force) and is expected to serve as a cushion (in this case, bladder 506b) will resist stretching. By contrast, the bladders 506 which are expected to receive a fluid and stretch in response to the force on another bladder (i.e. in this case bladders 506a and 506c are expected to stretch in response to the force on bladder 506b) will be of a move flexible material and will stretch more easily.

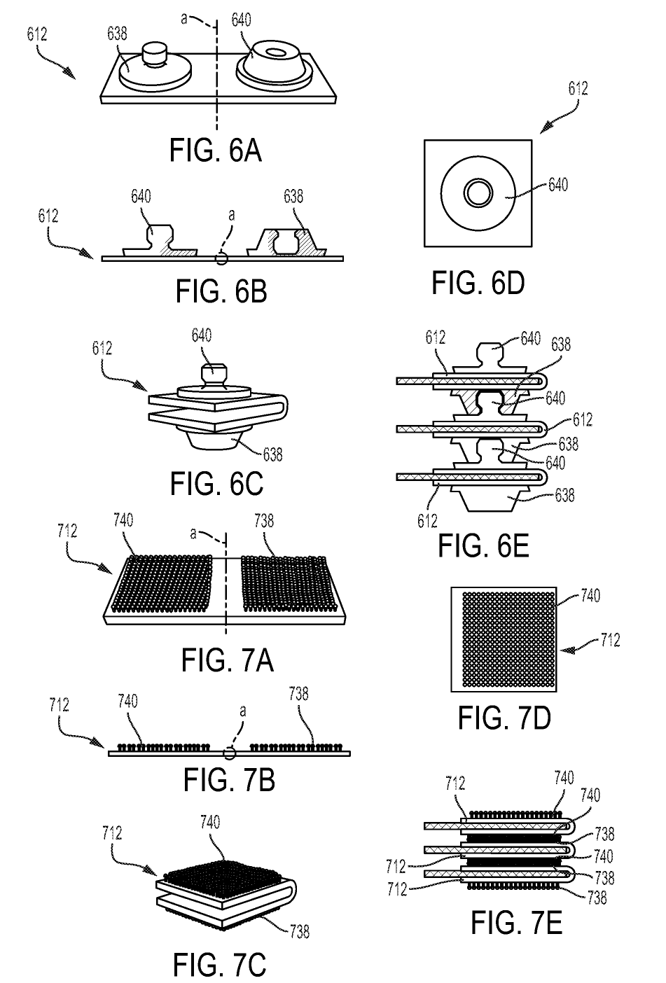

Referring now to FIGS. 6a-7e, two separate types of fasteners 612, 712 which can be incorporated into the support system are shown. In general, the fasteners 612, 712 in the support system are uniform such that any fastener 612, 712 within the system can couple with any other like fastener 612, 712 within the system. The fasteners 612, 712 can be permanently affixed to the other components of the system (i.e. attached to a cushion 102 by a border wall 108 as shown in FIGS. 2a, 3a, 4a, 4b) to allow for attachment of additional components. The two examples shown are a button fastener 612 (FIGS. 6a-6e) and a Velcro fastener 712 (FIGS. 7a-7e). In each case, the fastener has a male end 638, 738 and a female end 640, 740 (in the case of Velcro, the male and female ends 738, 740 being hooks and loops). The fasteners 612, 712 fold around a central axis “a”, allowing them to be folded around a border 108 and/or side 114, 116, 118, 120 of another component of the support system, such as a cushion 102. Uniform fasteners 612, 712 are used across a given system to allow for easy coupling between the various parts of the system. For example, if button fasteners 612 are used on multiple cushions 102 in the system, the male end 638, 738 of the fasteners 612, 712 on any cushion within the system could be attached to the female end 640, 740 of the fasteners 612, 712 on any cushion 102 within the system to attach any two cushions 102. Further, the fasteners 612, 712 are infinitely stackable (See FIGS. 6e and 7e) so multiple cushions 102, or additional external components such as a sanitary barrier or incontinence pads, could all be coupled together.

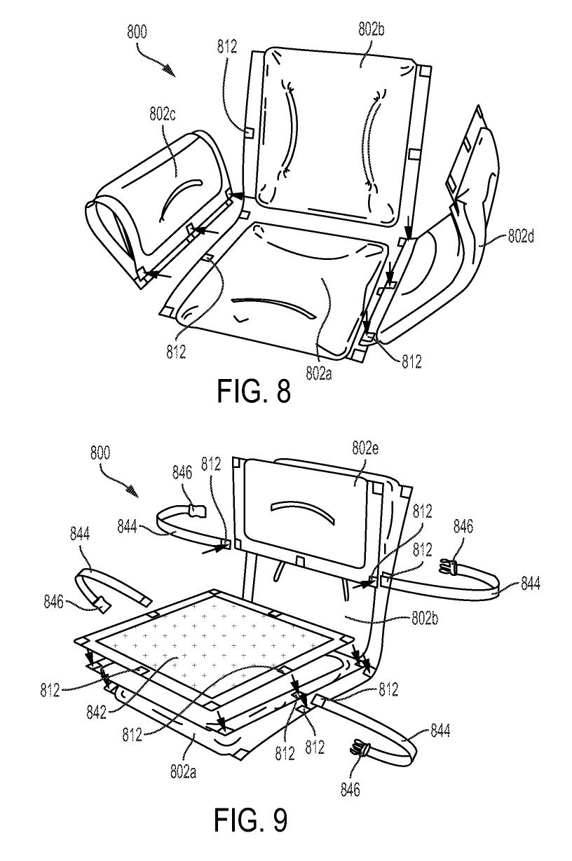

Referring now to FIGS. 8-9, various components are connected, via fasteners 812, to create support systems 800 in accordance with the subject technology. In FIG. 8, side cushions 802c, 802d are fastened to the lower cushion 802a. Since the fasteners 812 are uniform, the side cushions 802c, 802d can be looped over and fastened to themselves. Additionally or alternatively, as shown in FIG. 9, additional components can be placed directly over the cushions 802a, 802b of the support system 800. For example, a truncated upper cushion 802e is positioned over the upper cushion 802b to provide additional support near the top of the upper cushion 802b. An additional lower cushion 802a and a sanitary barrier 842 are also stacked on top of the lower cushion 802a and connected via the fasteners 812. In the example of FIG. 9, straps 844 are also attached to the system 800 via fasteners 812. The straps 844 include buckle ends 846 and can be wrapped around portions of the support system 800 to hold the components in place. The buckle ends 846 can be adjustment buckles which allow the strap 844 to be threated through loops to adjust the overall length of the straps 844. Alternatively, or additionally, the buckle ends 846 can include quick release connectors which allow the buckle ends 846 to be disengaged by simply squeezing the quick release connector, as are typically found in other known buckles.

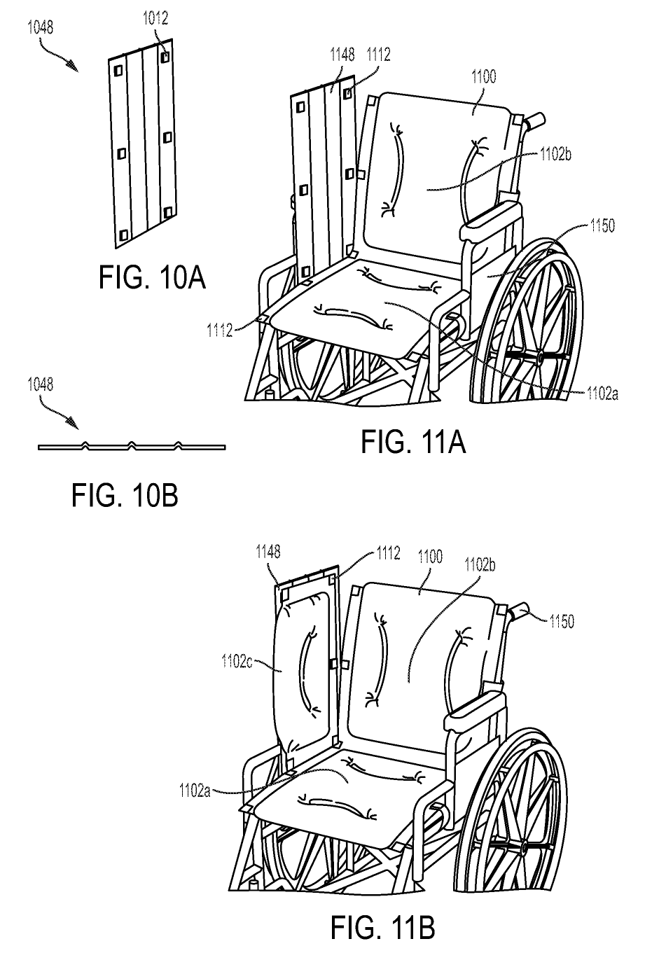

Referring now to FIGS. 10a-10b, in some embodiments, a rigid board 1048 can be included in the support system. The rigid board 1048 has fasteners 1012 which can couple with the fasteners 1012 within the support system. Typically, the rigid board 1048 is made of a stronger material (i.e. wood) as compared to the softer material of the cushions (i.e. typically cloth, foam, or other cushioning material). Further, while the cushions are flexible, the rigid board 1048 is much less flexible and provides a firm support. Therefore the rigid board 1048 can be positioned in an area where more support is required and then attached to the system via the fasteners 1012.

Referring now to FIGS. 11a-11c, support systems 1100 in accordance with the subject technology are shown, implemented to provide support over a wheelchair 1150. These systems 1100 represent orientations of various components that have been found to be effective within a support system 1100, although it should be noted that other orientations may also be used. Particularly, the support systems 1100 may be implemented with many other underlying base structures, such as a bed or a normal chair. In the first example given in FIG. 11a, the wheelchair 1150 includes attached buttocks and back cushions 1102a, 1102b. The rigid board 1148 is positioned along the side of the chair 1150, but can be moved and attached to the support system 1100 via the fasteners 1112. FIG. 10b shows a similar example although a truncated cushion 1102c is positioned over the rigid board 1148. Finally, in the example shown in FIG. 10c, an additional cushion 1102d is provided for the lower legs of the user. Further, side cushions 1102e, 1102f are looped around the arms of the wheelchair 1150 and fastened to themselves, as well as to the buttocks cushion 1102a. In this way, the fasteners 1112 allow for the inclusion of additional support, barriers for protection, and features such as side arms, leg cushioning and additional neck support.

Referring again to FIGS. 1a-1b the systems shown herein redirect air to support the body features for corrective and proper posture, displacing fluid within the system as shown by displacement arrows “f” when a user 110 utilizes the system 100. The functions created with the support system 100 include the displacement of fluid volume in cells to relieve the areas of the user 110 of larger physical structure and prominence while using the weight of the user's 110 physical structure to redirect the fluid flow into other cells that will support or restrict movement depending upon what is needed. Nozzles 152 allow for adjustments of fluid levels by providing a channel for the injection or release of fluid from individual cushions 102 or bladders 106. Multiple nozzles 152 can also be included to correspond to the various support zones within a given bladder 106. The nozzles 152 can be operated to control the distribution of fluid throughout the system 100 to reposition the user 110, or redistribute support for the user 110 Likewise, the valves can be adjusted or reconfigured to affect fluid location within the system 100 and modify the user's 110 support. Control of the fluid through the multiple cushions 102 and bladders 106, along with multiple support zones within the bladders 106, creates barriers and zones for wedge support to help prevent the user 110 from slipping out of position. Therefore the subject technology provides a support system 100 that results in improved comfort and care, particularly for the disabled and elderly.

It should be noted that while the example of cushions for a wheelchair is used frequently herein, the systems shown can be used for many types of cushions, including cervical and neck pillows. For example a system in accordance with the subject technology could be used by including bladders, similar to those described herein with respect to the cushions shown on the wheelchair, within pillows Likewise, the fastener systems shown herein could be used to link multiple pillows, or to take external components to the system. In this way, a support system can be formed which uses one or more pillows in much the same way that the support system for a wheelchair was created, as described above. Likewise the support system can be implemented as part of other arrangements that seek to provide support, cushioning, and/or comfort to a user.

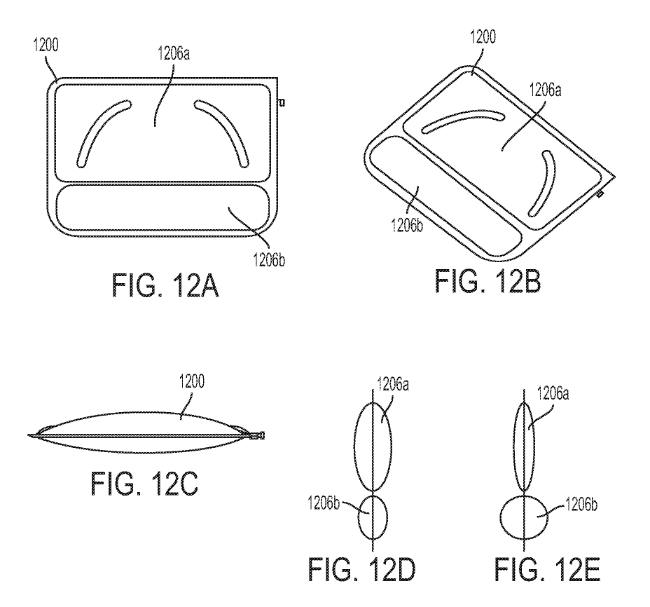

In another example, referring now to FIGS. 12a-12e, the system is shown being implemented within a pillow 1200. The pillow 1200 functions similar to the other systems described herein, and has an upper bladder 1206a fluidly connected to a lower bladder 1206b by interconnections (not distinctly shown). When the upper bladder 1206a is compressed (compare FIG. 12d and FIG. 12e), fluid is forced into the lower bladder 1206b causing it to expand. Similarly, when the lower bladder 1206b is compressed fluid is forced into the upper bladder 1206a causing it to expand.

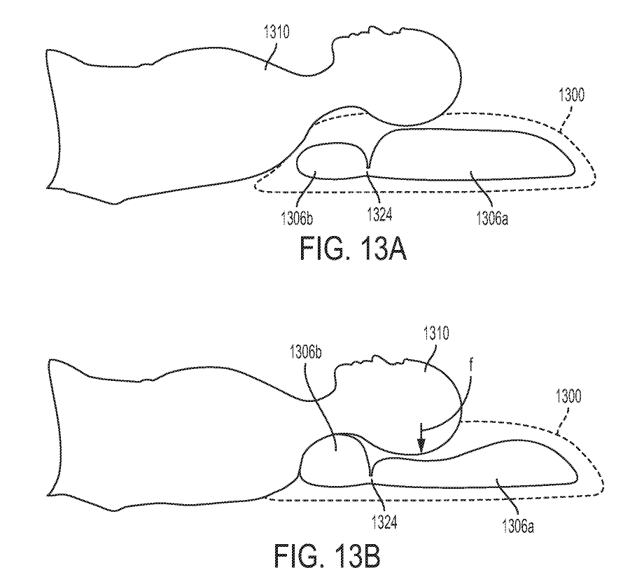

Referring now to FIGS. 13a and 13b, the operation of a system in accordance with the subject technology which is implemented within a pillow 1300 is shown. The pillow 1300 is a cushion which includes a first bladder 1306a and a second bladder 1306b. In FIG. 13a, the user's 1310 head is elevated above the pillow 1300. In FIG. 13b, the user 1310 has lowered their head along arrow “f” onto the pillow 1300. When the user's 1310 head contacts the pillow 1300 a force is applied to the first bladder 1306a, forcing fluid is through the interconnect 1324 into the second bladder 1306b. The first bladder 1306a is deformed as the user's 1310 head creates a depression in the first bladder 1306a. Some fluid is forced to the portion of the first bladder 1306a above the user's 1310 head, providing support, while the depressed area provides cushioning. The second bladder 1306b inflates as fluid is pushed into it, rising up to provide a support under the user's 1310 neck. In this way, the pillow 1300 provides both support and cushioning for the user 1310.

It will be appreciated by those of ordinary skill in the pertinent art that the functions of several elements may, in alternative embodiments, be carried out by fewer elements, or a single element. Similarly, in some embodiments, any elements designed to perform a function may perform fewer, or different, operations than those described with respect to the illustrated embodiment. Also, elements configured to perform a particular function (e.g., valves, interconnections, bladders and the like) shown as distinct for purposes of illustration may be incorporated within other elements in a particular implementation.

While the subject technology has been described with respect to preferred embodiments, those skilled in the art will readily appreciate that various changes and/or modifications can be made to the subject technology without departing from the spirit or scope of the invention.

1. A support system comprising:
a first bladder containing a fluid;
a second bladder containing a fluid, the second bladder fluidly connected to the first bladder; and
a valve controlling fluid flow between the first bladder and the second bladder,
wherein:
applying a force to the first bladder causes a reactionary force in the second bladder; and
applying a force to the second bladder causes a reactionary force in the first bladder.

2. The support system of claim 1 wherein the first bladder has an axial partition dividing the first bladder into a plurality of support zones.

3. The support system of claim 2 wherein the first bladder has a transverse partition further dividing the first bladder into a plurality of support zones.

4. The support system of claim 3 wherein the second bladder has an axial partition dividing the second bladder into a plurality of support zones.

5. The support system of claim 4 wherein the second bladder has a transverse partition dividing the second bladder into a plurality of support zones.

6. The support system of claim 2 further comprising a plurality of zone valves controlling fluid flow between the support zones.

7. The support system of claim 1 further comprising a first cushion enclosing the first bladder and the second bladder.

8. The support system of claim 7 further comprising a plurality of first cushion fasteners attached to the first cushion.

9. The support system of claim 8 further comprising a disposable sanitary barrier attached to the first cushion via the first cushion fasteners.

10. The support system of claim 9 further comprising adjustment straps with quick release connectors, the adjustment straps coupled to the support system via the fasteners.

11. The support system of claim 10 further comprising:
a second cushion containing a third bladder filled with a fluid; and
a plurality of second cushion fasteners attached to the second cushion, some of the plurality of second cushion fasteners coupling with some of the plurality of first cushion fasteners to couple the first cushion and the second cushion.

12. The support system of claim 11 further comprising a rigid board attached to the second cushion via coupling with the first cushion fasteners.

13. The support system of claim 11 further comprising:
a third cushion containing a fourth bladder filled with a fluid; and
a plurality of third cushion fasteners attached to the third cushion, some of the plurality of third cushion fasteners coupling with some of the plurality of second cushion fasteners to couple the second cushion and the third cushion.

14. The support system of claim 1 wherein the first bladder includes a nozzle for:
injecting additional fluid into the first bladder; and releasing fluid from the first bladder.

15. A support system comprising:
a first cushion divided into a plurality of bladders filled with a fluid, the plurality of bladders being connected by fluid interconnections; and
a second cushion coupled to the first cushion, the second cushion divided into a plurality of bladders filled with a fluid, the bladders being connected by fluid interconnections,
wherein:
applying a force to one of the plurality of bladders causes a reactionary force in a different one of the plurality of bladders in the same respective cushion.

16. The support system of claim 15 wherein the first cushion includes a nozzle in fluid connection with one of the plurality of bladders of the first cushion for: injecting additional fluid into the first cushion; and releasing the fluid from the first cushion.

17. The support system of claim 16 wherein the at least one of the plurality of bladders is divided into a plurality of support zones of different flexibility.

18. The support system of claim 17 further comprising at least one fluid interconnection between the plurality of support zones, the at least one interconnection including an adjustable valve operable to control fluid flow between the support zones.

19. The support system of claim 18 further comprising:
a plurality of fasteners attached to the first cushion; and
a plurality of fasteners attached to the second cushion,
wherein the plurality of fasteners have a uniform structure for coupling with other fasteners of the same uniform structure.

20. The support system of claim 19 further comprising:
a rigid board attached to the second cushion by the fasteners,
wherein the first cushion is positioned perpendicular to the second cushion.
